(19) United States
(12) Patent Application Publication
(10) Pub. No.: US 2023/0341529 A1
(43) Pub. Date: Oct. 26, 2023

(54) TARGET DETECTION METHOD, LIDAR AND STORAGE MEDIUM

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 18/134,028

(22) Filed: Apr. 12, 2023

(30) Foreign Application Priority Data
Apr. 24, 2022 (CN) 202210434277.X

(51) Int. Cl. G01S 7/487; G01S 17/10; G01S 7/484; G01S 7/4865

(52) U.S. Cl. CPC G01S 7/487; G01S 17/10; G01S 7/484; G01S 7/4865

(57) ABSTRACT

This application provides a target detection method, a LiDAR; and a storage medium. The method includes: obtaining an echo signal, where the echo signal is obtained by sampling a reflected wave received by the LiDAR; performing a matching operation on the echo signal and a preamble signal, to obtain a valid echo signal for a target object, where the preamble signal is obtained by sampling a reflected wave corresponding to a window; determining a threshold for the valid echo signal; determining a leading edge moment and a trailing edge moment based on the threshold; and determining a distance between the LiDAR and the target object based on the leading edge moment and the trailing edge moment.

### CROSS-REFERENCE TO RELATED APPLICATION

The present application claims the benefit of priority to China Patent Application No. 202210434277.X, filed on Apr. 24, 2022, which is hereby incorporated by reference in its entirety.

### TECHNICAL FIELD

This application pertains to the detection field of LiDAR, and in particular, relates to a target detection method, a LiDAR and a storage medium.

### BACKGROUND

A transceiver system of a LiDAR includes an emission unit and a receiving unit. The emission unit is configured to emit an outgoing laser beam, and the outgoing laser beam is received by the receiving unit after being reflected by a target object, thereby achieving target detection.

However, because the outgoing laser beam emitted by the emission unit is partly reflected inside the LiDAR to form stray light, which is received by the receiving unit simultaneously, normal reception through a receiving optical path is interfered with, thereby affecting ranging accuracy and causing a ranging inaccuracy problem for a short-range target object.

### SUMMARY

In view of this, embodiments of this application provide a target detection method, a LiDAR, and a storage medium, which can resolve a problem that the LiDAR ranges a short-range target object inaccurately.

A first aspect of the embodiments of this application provides a target detection method, applied to a LiDAR, where the method includes: obtaining an echo signal, where the echo signal is obtained by sampling an echo laser beam received by the LiDAR; performing a matching operation on the echo signal and a preamble signal, to obtain a valid echo signal for a target object, where the preamble signal is obtained by sampling an echo laser beam corresponding to a window; determining a threshold for the valid echo signal; determining a leading edge moment and a trailing edge moment based on the threshold: and determining a distance between the LiDAR and the target object based on the leading edge moment and the trailing edge moment.

In some embodiments, before performing a matching operation on the echo signal and a preamble signal, the method further includes: determining whether a signal strength of the echo signal is greater than a first preset value; and if the signal strength of the echo signal is greater than the first preset value, reducing an emission power for the outgoing laser beam of the LiDAR, and obtaining an echo signal again.

In some embodiments, performing a matching operation on the echo signal and a preamble signal includes: determining a measured distance corresponding to the echo signal; if the measured distance is less than a second preset value, determining a similarity value between the echo signal and the preamble signal; and if the similarity value is less than a preset value, performing the matching operation on the echo signal and the preamble signal.

In some embodiments, performing a matching operation on the echo signal and a preamble signal, to obtain a valid echo signal for a target object includes: obtaining a preamble signal corresponding to the echo signal; performing matching operation on the echo signal and the preamble signal, to obtain an intersection point of the echo signal and the preamble signal; and obtaining the valid echo signal based on the intersection point.

In some embodiments, obtaining a preamble signal corresponding to the echo signal includes: determining an emission power for an outgoing laser beam corresponding to the echo signal; and obtaining a preamble signal corresponding to the emission power.

In some embodiments, determining a threshold for the valid echo signal includes: determining a signal strength of the valid echo signal; determining a number of thresholds based on the signal strength of the valid echo signal; and determining the threshold for the valid echo signal based on a peak value of the valid echo signal, an extreme value of the valid echo signal and the number of thresholds.

In some embodiments, determining a leading edge moment and a trailing edge moment based on the threshold includes: determining, from the valid echo signal, a first sampling point that is earlier than a peak value and that satisfies that a difference between the first sampling point and the threshold is within a first preset range, and a second sampling point that is later than the peak value and that satisfies that a difference between the second sampling point and the threshold is within a second preset range; and performing an interpolation operation on a moment corresponding to the first sampling point to obtain the leading edge moment, and performing an interpolation operation on a moment corresponding to the second sampling point to obtain the trailing edge moment.

In some embodiments, performing a matching operation on the echo signal and a preamble signal, to obtain a valid echo signal for a target object includes: correcting the preamble signal based on environment information when the echo signal is received, to obtain a corrected preamble signal; and performing a matching operation on the echo signal and the corrected preamble signal, to obtain the valid echo signal for the target object.

A second aspect of the embodiments of this application provides a target detection apparatus, applied to a LiDAR, including: an obtaining module, configured to obtain an echo signal, where the echo signal is obtained by sampling an echo laser beam received by the LiDAR; a matching module, configured to perform a matching operation on the echo signal and a preamble signal, to obtain a valid echo signal for a target object, where the preamble signal is obtained by sampling an echo laser beam corresponding to a window; a first calculation module, configured to determine a threshold for the valid echo signal; a second calculation module, configured to determine a leading edge moment and a trailing edge moment based on the threshold; and a third calculation module, configured to determine a distance between the LiDAR and the target object based on the leading edge moment and the trailing edge moment.

A third aspect of the embodiments of this application provides a LiDAR, including a memory, a processor, and a computer program stored in the memory and capable of running on the processor, where when the processor executes the computer program, the target detection method in the first aspect is implemented.

A fourth aspect of the embodiments of this application provides a computer-readable storage medium, where the computer-readable storage medium stores a computer program, and when the computer program is executed by a processor, the target detection method in the first aspect is implemented.

A fifth aspect of the embodiments of this application provides a computer program product, where when the computer program product runs on a LiDAR, the LiDAR performs the target detection method in any embodiment of the first aspect.

The embodiments of this application have the following effects: The echo signal is obtained, and the matching operation is performed on the echo signal and the preamble signal, to obtain the valid echo signal of the target object, thereby reducing interference from the preamble signal on distance measurement. After the valid echo signal is obtained, the threshold of the valid echo signal is determined, and the leading edge moment and the trailing edge moment are determined based on the threshold, so that an interference signal can be further ruled out and the distance between the LiDAR and the target object is further determined based on the leading edge moment and the trailing edge moment, thereby improving accuracy of the obtained distance between the LiDAR and the target object.

### BRIEF DESCRIPTION OF DRAWINGS

Exemplary embodiments of this application are described with reference to the accompanying drawings, to illustrate the foregoing and other objectives, features, and advantages of this application. In the exemplary embodiments of this application, the same reference numerals generally represent the same components.

FIG. 1 is a schematic diagram of a transceiver system of a LiDAR according to an embodiment of this application;

FIG. 2 is a flowchart of implementation of a target detection method according to an embodiment of this application;

FIG. 3 is a schematic diagram of a preamble signal according to an embodiment of this application;

FIG. 4 is a schematic diagram of an echo signal according to an embodiment of this application;

FIG. 5 is a schematic diagram of a valid echo signal according to an embodiment of this application;

FIG. 6 is a schematic diagram of a threshold determining method according to an embodiment of this application;

FIG. 7 is a schematic diagram of a threshold determining method according to another embodiment of this application;

FIG. 8 is a schematic diagram of a target detection apparatus according to an embodiment of this application; and

FIG. 9 is a schematic structural diagram of a LiDAR according to an embodiment of this application.

### DETAILED DESCRIPTION

For the purpose of illustration rather than limitation, the following describes details such as a system structure and technology, to facilitate a better understanding of the embodiments of this application. However, a person skilled in the art should understand that this application can also be implemented in other embodiments without these details. In other cases, detailed descriptions of well-known systems, apparatuses, circuits, and methods are omitted, to prevent unnecessary details from causing distraction from the description of this application.

It should be understood that when used in this specification and appended claims, a term “include” indicates existence of a described feature, integrity, a step, an operation, an element, and/or a component, but does not exclude existence or addition of one or more other features, integrity, steps, operations, elements, components, and/or a collection thereof.

It should also be understood that the terms used in this specification of this application are only used to describe the specific embodiments and are not intended to limit this application. As used in this specification and the appended claims of this application, unless otherwise the context clearly indicates another case, singular forms of “a,” “an,” and “the” are intended to include plural forms.

In addition, in the description of the present application, the terms such as “first” and “second” are merely intended for the purpose of description, and shall not be understood as an indication or implication of relative importance.

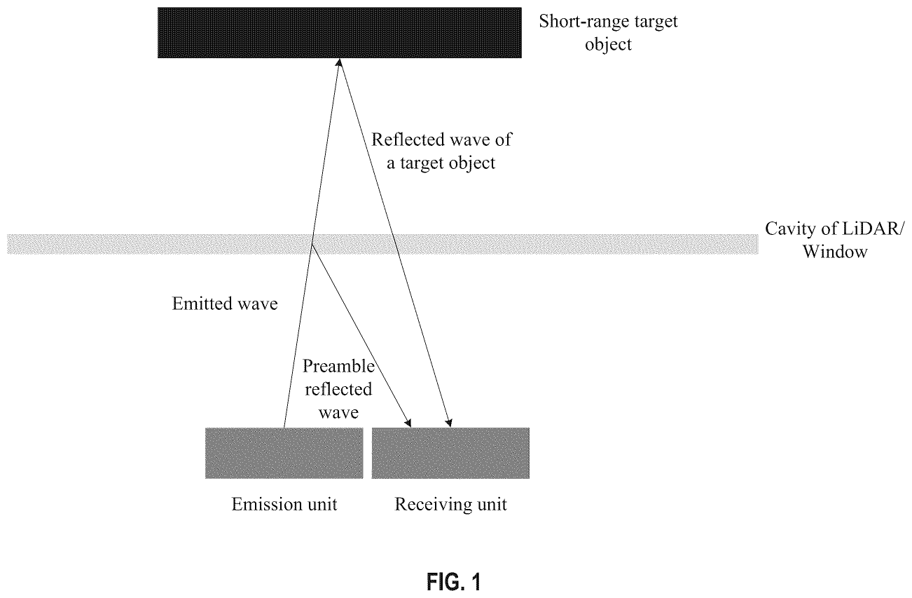

As shown in FIG. 1, in a LiDAR, due to existence of an inner wall of a LiDAR cavity or a window, an outgoing laser beam emitted by the emission unit is partly reflected inside the LiDAR to form stray light to be received by a receiving unit and overlapped with an actual short-range echo, normal reception through a receiving optical path is interfered, thereby affecting the ranging accuracy and causing a ranging inaccuracy problem for a short-range target object.

Therefore, this application provides a target detection method. A preamble signal is eliminated by performing a matching operation on a received echo signal and the preamble signal, to obtain a valid echo signal. Then, a threshold is determined for the valid echo signal, and a leading edge moment and a trailing edge moment are determined based on the threshold, so that an accurate peak point of the echo signal can be further obtained, to obtain accurate echo time and then determine a distance between the LiDAR and a target object based on the accurate echo time, thereby improving the accuracy of the obtained distance between the LiDAR and the target object.

The target detection method provided in this application is exemplarily described below.

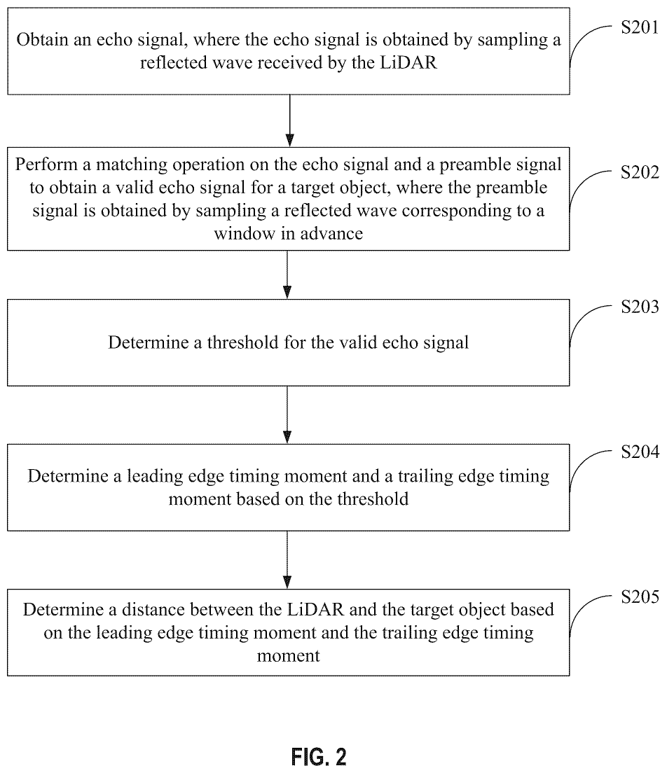

The target detection method provided in embodiments of this application is applied to the LiDAR. Referring to FIG. 2, the target detection method provided in an embodiment of this application includes the following steps:

S201. Obtain an echo signal, where the echo signal is obtained by sampling an echo laser beam received by the LiDAR.

In some embodiments, the emission unit of the LiDAR emits an outgoing laser beam, and a receiving unit of the LiDAR receives an echo laser beam reflected by an obstacle and samples the echo laser beam, to obtain the echo signal. Exemplarily, if the receiving unit is a detector of Avalanche Photon Diode (APD) or Silicon Photomultiplier (SiPM), Analog-to-Digital Converter (ADC) can be used for sampling to obtain the echo signal. If the receiving unit is Single Photon Avalanche Diode (SPAD), Time-to-Digital Converter (TDC) may be used for sampling multiple times, multiple sampled data can be superimposed to obtain histogram waveform, and the histogram waveform is used as the echo signal.

Herein, it can be understood that when the LiDAR measures a short-range, target object, because time of receiving the echo signal from the target object is within a preset time range, an echo laser beam received by the LiDAR is obtained by superimposing an echo laser beam reflected by the target object onto an echo laser beam formed by reflecting an emitted laser beam in a cavity, and an echo signal obtained by sampling the echo laser beam is also a superimposed signal of the echo signal of the target object and a preamble signal reflected in the cavity. Herein, the preamble signal may include, for example, an echo signal formed by reflection of the outgoing laser beam emitted by the emission unit of the LiDAR on an inner wall of an emission cavity and/or an echo signal formed by reflection of the outgoing laser beam emitted by the emission unit on the window

S202. Perform a matching operation on the echo signal and a preamble signal to obtain a valid echo signal for a target object, where the preamble signal is obtained by sampling an echo laser beam corresponding to a window.

In some embodiments, matching operation is performed on the echo signal and the preamble signal, to obtain an intersection point of the echo signal and the preamble signal; and the valid echo signal is obtained based on the intersection point.

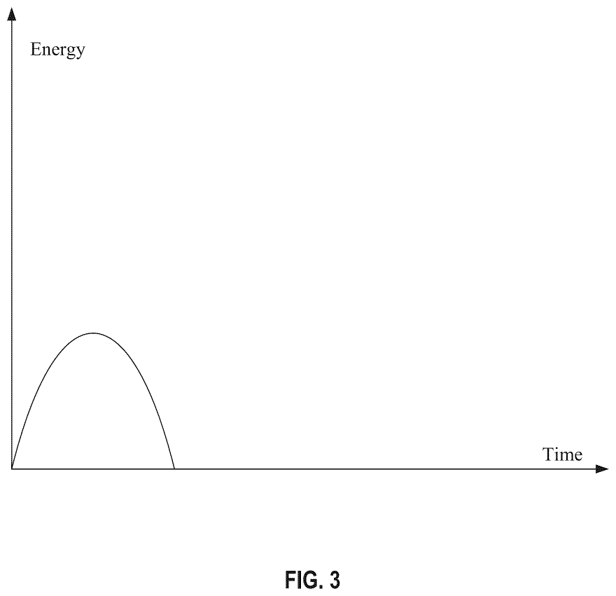

Herein, when there is no target object, the LiDAR emits an outgoing laser beam, and then samples a received echo laser beam to obtain a preamble signal shown in FIG. 3. Herein, it can be understood that different emission powers may be used to calibrate the preamble signal as required.

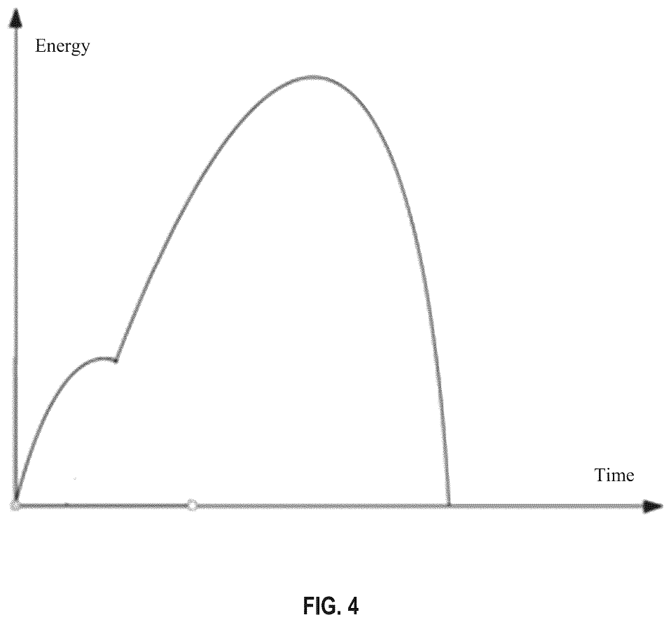

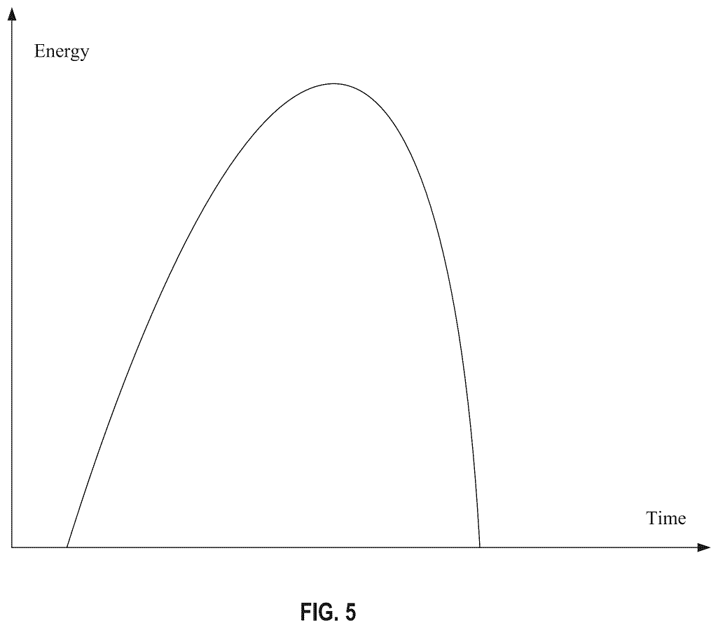

When there is a target object, the LiDAR emits an outgoing laser beam, and then samples a received reflected wave to obtain an echo signal shown in FIG. 4, In the same coordinate system, matching is performed on a waveform diagram of the echo signal and a waveform diagram of the preamble signal, to obtain the intersection point of the echo signal and the preamble signal, and the preamble signal is subtracted from the echo signal in time domain based on the intersection point to obtain a valid echo signal shown in FIG. 5, that is, a valid echo signal with the preamble signal eliminated, thereby reducing impact of the preamble signal on subsequent distance measurement and improving the accuracy of a measured distance between the LiDAR and the target object.

In some embodiments, when a parameter of the outgoing laser beam changes, a corresponding echo signal and preamble signal also change. In order to improve matching accuracy of the echo signal and the preamble signal, after the echo signal is obtained, a parameter of the outgoing laser beam corresponding to the echo signal is determined, then the preamble signal is obtained for the parameter of the outgoing laser beam, and a matching operation is performed on the echo signal and the corresponding preamble signal. Exemplarily, the parameter of the outgoing laser beam refers to the emission power for the outgoing laser beam. The LiDAR determines the emission power for the outgoing laser beam corresponding to the echo signal, and obtains the preamble signal for the emission power to perform the matching operation.

In some embodiments, when the preamble signal is sampled, the emission power corresponding to the preamble signal is correspondingly stored. After the echo signal is obtained, the preamble signal sampled is fitted based on an emission power corresponding to the echo signal, to obtain a fitted preamble signal. Exemplarily, preamble signals corresponding to different emission powers are obtained. Based on a relationship between the preamble signals corresponding to different emission powers and a preamble signal for a standard emission power, a fitting coefficient of the preamble signals corresponding to different emission powers relative to the preamble signal for the standard emission power is determined. After the emission power of the echo signal is determined, a corresponding fitting coefficient is obtained based on the emission power of the echo signal, and the preamble signal for the standard power is fitted based on the fitting coefficient to obtain a fitted preamble signal. The fitted preamble signal is the preamble signal corresponding to the emission power of the echo signal. Then the matching operation is performed on the echo signal and the fitted preamble signal, to obtain a valid echo signal of the target object, which can improve the accuracy of the matching operation and further improve accuracy of the obtained valid echo signal.

In some embodiments, preamble signals corresponding to different emission powers may also be prestored, and after the echo signal is obtained, a corresponding preamble signal is determined based on the emission power corresponding to the echo signal, and matching is performed on the corresponding preamble signal and the echo signal.

In some embodiments, preamble signals for different environment information are obtained, where the environment information may be, for example, environment temperature. Then, based on the preamble signals for different environment information and the preamble signal in a standard environment, adjustment coefficients of the preamble signals in different environments relative to the preamble signal in the standard environment are determined. When the echo signal is obtained, the environment information when the echo signal is received is detected simultaneously, an adjustment coefficient corresponding to the environment information when the echo signal is received is obtained, and the preamble signal in the standard environment is corrected based on the adjustment coefficient to obtain a corrected preamble signal. Exemplarily, because the environmental information affects amplitude and delay in waveform of a preamble echo, the adjustment coefficient may be set as a time difference coefficient and an amplitude coefficient. After the corrected preamble signal is obtained, the matching operation is performed on the echo signal and the corrected preamble signal, to obtain the valid echo signal of the target object, which can reduce impact of the environment on measurement accuracy and improve the accuracy of the target detection.

In some embodiments, after the LiDAR emits the outgoing laser beam, when the echo signal is received, it is determined whether there is a target object based on the echo signal and the preamble signal. For example, a first difference between height of a peak of the echo signal and height of a peak of the preamble signal and a second difference between waveform width of the echo signal and waveform width of the preamble signal can be determined. If the first difference and/or the second difference is within a preset range, this indicates that there is only the preamble signal in the echo signal and it is further determined that there is no target object; or if the first difference and/or the second difference is not within the preset range, this indicates that the echo signal is a superimposed signal of the preamble signal and the valid echo signal of the target object and it is further determined that there is the target object. If it is determined that there is the target object, an emission power for the outgoing laser beam of the LiDAR is reduced and an echo signal is obtained again. Because the power of receiving the preamble signal by the LiDAR is also relatively great when the emission power is relatively great, received echo signals are saturated, and as a result, a complete echo signal cannot be received. Therefore, when it is determined that there is the target object, reducing the emission power for the outgoing laser beam can ensure that the LiDAR receives the complete echo signal, thereby improving, the accuracy of the target detection. In some embodiments, when it is determined that there is a short-range target object based on a near-field echo and the preamble signal, another emission parameter of the LiDAR can also be adjusted to adaptively detect a scenario of the short-range target object, thereby improving the accuracy of detecting the short-range target object.

In some embodiments, after the echo signal is obtained, a measured distance corresponding to the echo signal is determined, that is, a measured distance between the LiDAR and the obstacle is determined based on the echo signal. If the measured distance is less than a second preset value, this indicates that an obstacle detected via the echo signal is the short-range obstacle, the echo signal may include an echo signal of the short-range obstacle and/or the preamble signal, and a similarity value between the echo signal and the preamble signal may be determined. If the similarity value is less than a preset value, this indicates that the echo signal further includes the echo signal of the target object, in addition to the preamble signal, and the matching operation is performed on the echo signal and the preamble signal, to obtain the valid echo signal. If the similarity value is greater than the preset value, this indicates that the echo signal only includes the preamble signal, and detection is ended, which can avoid invalid detection.

In some embodiments, after the echo signal is obtained, the method further includes: determining whether a signal strength of the echo signal is greater than a first preset value; and if the signal strength of the echo signal is greater than the first preset value, that is, the echo signal is saturated data, reducing an emission power for the outgoing laser beam of the LiDAR, and obtaining an echo signal again, which can ensure that the LiDAR receives an actual echo signal, and improve the accuracy of the target detection.

Herein, it can be understood that before determining whether a signal strength of the echo signal is greater than a first preset value, the method further includes: obtaining the signal strength of the echo signal. It can be understood that the strength of the echo signal can be determined by obtaining an area, pulse width, a peak value or amplitude of the echo signal. Herein, a parameter for determining echo strength can be selected based on a hardware design need.

S203, Determine a threshold for the valid echo signal.

In some embodiments, based on the peak value in the valid echo signal, one or more thresholds are respectively determined on two sides of the peak value.

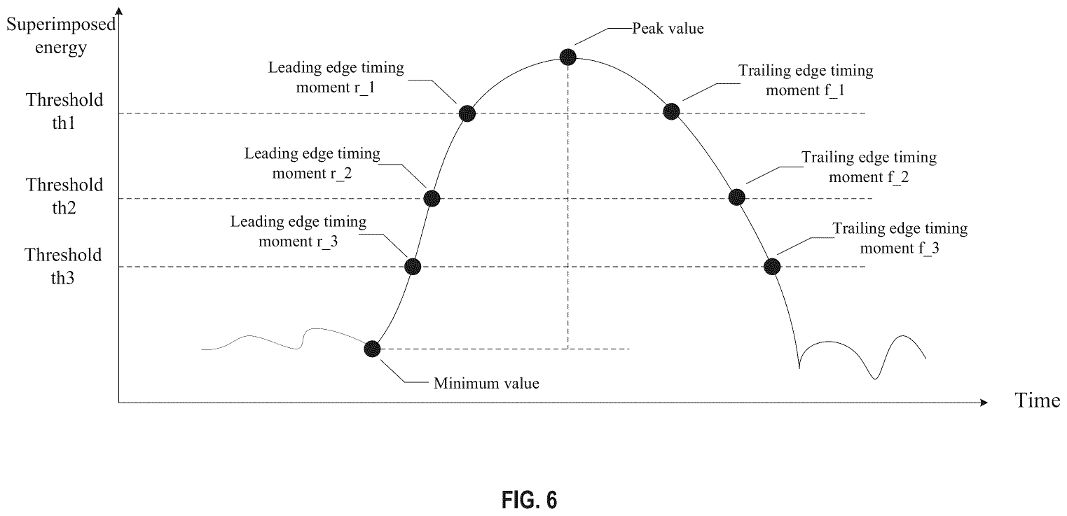

In some embodiments, the threshold is determined for the valid echo signal based on a peak value of the valid echo signal, an extreme value of the valid echo signal and the number of thresholds. For example, as shown in FIG. 6, the echo signal is histogram waveform obtained by superimposing multiple sampled data, the minimum value adjacent to the peak value is used as the extreme value, and three thresholds are determined between the peak value and the extreme value, namely, threshold th1, threshold th2, and threshold th3, respectively. Herein, thresholds may be determined between the peak value and the extreme value at intervals of equal amplitude, or the thresholds may be determined between the peak value and the extreme value at intervals of equal time. For example, a band between the peak value and the extreme value is divided into 4 equal parts at intervals of equal amplitude, to obtain 3 thresholds. Alternatively, a band between the peak value and the extreme value is divided into 4 equal parts at intervals of equal time, to obtain 3 thresholds.

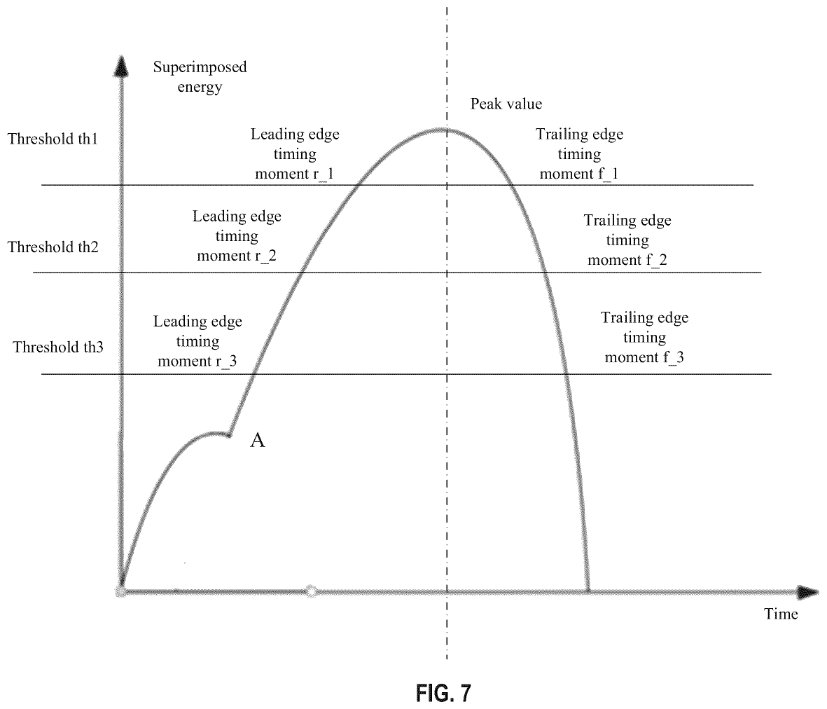

For another example, as shown in FIG. 7. an intersection point of waveform of a preamble signal and waveform of a valid echo signal is A, the intersection point A is used as the extreme value, and the band between the peak value and the extreme value is divided into 4 equal parts at intervals of equal amplitude or equal time, to obtain threshold th1, threshold th2, and threshold th3.

More selected thresholds indicate higher calculation accuracy and more calculation resources consumed in a calculation process. Therefore, an appropriate number of thresholds can be selected based on a target detection scenario. In some embodiments, the number of thresholds is determined based on the signal strength of the valid echo signal. For example, the greater signal strength indicates the greater number of thresholds; or the smaller signal strength indicates the smaller number of thresholds, which can improve calculation accuracy.

In some embodiments, after the valid echo signal is determined, the signal strength of the valid echo signal is determined based on an area, pulse width, a peak value, or amplitude of the valid echo signal, and then the number of thresholds is determined based on the signal strength of the valid echo signal.

In some embodiments, the number of thresholds can also be determined based on an accuracy requirement for the target detection. For example, when the accuracy requirement for the target detection is high, a large number of thresholds are set; or when the accuracy requirement for the target detection is low, a small number of thresholds are set, so that the number of thresholds fits the scenario of the target detection. After the number of thresholds is set, the threshold can be determined based on the peak value in the valid echo signal and the number of thresholds. For example, after the number of thresholds is set, the band between the peak value and the extreme value in the valid echo signal is determined, a time interval is determined based on duration corresponding to the band and the number of thresholds, or an amplitude interval is determined based on amplitude corresponding to the band and the number of thresholds, and then the threshold can be determined based on the time interval or the amplitude interval.

S204. Determine a leading edge moment and a trailing edge moment based on the threshold.

In some embodiments, a first sampling point that is earlier than a peak value and that satisfies that a difference between the first sampling point and the threshold is within a first preset range, and a second sampling point that is later than the peak value and that satisfies that a difference between the second sampling point and the threshold is within a second preset range are determined from the valid echo signal. The sampling point earlier than the peak value refers to a sampling point earlier than a moment corresponding to the peak value, and the sampling point later than the peak value refers to a sampling point later than a moment corresponding to the peak value. For example, as shown in FIG. 6, a sampling point on a band on a left side of the peak value is a sampling point earlier than the peak value, and a sampling point on a band on a right side of the peak value is a sampling point later than the peak value. After the first sampling point and the second sampling point are obtained, an interpolation operation is performed on a moment corresponding to the first sampling point to obtain a leading edge moment, and an interpolation operation is performed on a moment corresponding to the second sampling point to obtain a trailing edge moment. Herein, a linear interpolation method or Newton's interpolation method may be used to perform the interpolation operation. The leading edge moment and the trailing edge moment are determined based on the threshold, which can more accurately obtain echo time and improve the accuracy of the target detection. For example, as shown in FIG. 6 and FIG. 7, leading edge moment r_1 is determined based on a first sampling point corresponding to the threshold th1, and trailing edge moment f_1 is determined based on a second sampling point corresponding to the threshold th1; leading edge moment r_2 is determined based on a first sampling point corresponding to the threshold th2, and trailing edge moment f_2 is determined based on a second sampling point corresponding to the threshold th2; and leading edge moment r_3 is determined based on a first sampling point corresponding to the threshold th3, and trailing edge moment f_3 is determined based on a second sampling point corresponding to the threshold th3.

In some embodiments, fitting may also be performed on the first sampling point, to determine the leading edge moment based on a fitted straight line, and fitting is performed on the second sampling point, to determine the trailing edge moment based on a fitted straight line.

S205. Determine a distance between the LiDAR and the target object based on the leading edge moment and the trailing edge moment.

In some embodiments, if the number of thresholds is 1, then the leading edge moment and the trailing edge moment are averaged to obtain a target moment, and a product of multiplying the target moment by the speed of light is divided by 2 to obtain a distance between the LiDAR and the target object. If there are multiple thresholds, leading edge moments and trailing edge moments corresponding to the thresholds can be averaged to obtain the target moment. If there are multiple thresholds, weighted averaging can also be performed on leading edge moments and trailing edge moments corresponding to the thresholds based on weight corresponding to the leading edge moments and the trailing edge moments to obtain the target moment. In some embodiments, a moment corresponding to an intermediate value (average) of the peak value and the extreme value is determined, and the extreme value is the minimum value adjacent to the peak value or the intersection point of the waveform of the preamble signal and the waveform of the valid echo signal. The larger the difference between a moment corresponding to the intermediate value and the leading edge moment and the trailing edge moment, the smaller the corresponding weight. After the target moment is obtained, the distance between the LiDAR and the target object can be calculated based on the target moment and the speed of light.

In some embodiments, the echo signal is obtained, and the matching operation is performed on the echo signal and the preamble signal, to obtain the valid echo signal of the target object, thereby reducing interference from the preamble signal on distance measurement. After the valid echo signal is obtained, the threshold of the valid echo signal is determined, and the leading edge moment and the trailing edge moment are determined based on the threshold, so that the accurate echo moment can be obtained and the distance between the LiDAR and the target object is further determined based on the obtained accurate echo moment, thereby improving the accuracy of the obtained distance between the LiDAR and the target object.

It should be understood that a sequence number of each step in the foregoing embodiments does not mean an execution sequence. An execution sequence of each process should be determined based on a function and internal logic of each process, and should not constitute any limitation to an implementation process of the embodiments of this application.

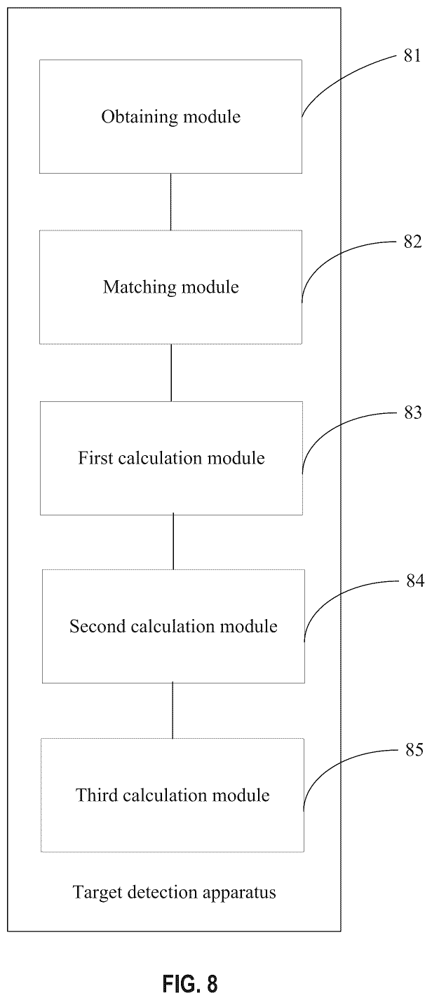

Corresponding to the target detection method in the foregoing embodiment, FIG. 8 shows a structural block diagram of a target detection apparatus according to an embodiment of this application. For ease of description, only a part related to the embodiments of this application is shown.

As shown in FIG. 8, the target detection apparatus is applied to a LiDAR, including: an obtaining module 81, configured to obtain an echo signal, where the echo signal is obtained by sampling a reflected wave received by the LiDAR; a matching module 82, configured to perform a matching operation on the echo signal and a preamble signal, to obtain a valid echo signal for a target object, where the preamble signal is obtained by sampling a reflected wave corresponding to a window; a first calculation module 83, configured to determine a threshold for the valid echo signal; a second calculation module 84, configured to determine a leading edge moment and a trailing edge moment based on the threshold; and a third calculation module 85, configured to determine a distance between the LiDAR and the target object based on the leading edge moment and the trailing edge moment.

In some embodiments, the matching module 82 is further configured to: determine whether a signal strength of the echo signal is greater than a first preset value; and if the signal strength of the echo signal is greater than the first preset value, reduce an emission power fir the outgoing laser beam of the LiDAR, and obtain an echo signal again.

In some embodiments, the matching module 82 is configured to: determine a measured distance corresponding to the echo signal, if the measured distance is less than a second preset value, determine a similarity value between the echo signal and the preamble signal; and if the similarity value is less than a preset value, perform the matching operation on the echo signal and the preamble signal.

In some embodiments, the matching module 82 is configured to: obtain a preamble signal corresponding to the echo signal; perform matching operation on the echo signal and the preamble signal, to obtain an intersection point of the echo signal and the preamble signal; and obtain the valid echo signal based on the intersection point.

In some implementations, the obtaining module 801 is configured to: determine an emission power for an outgoing laser beam corresponding to the echo signal; and obtain a preamble signal corresponding to the emission power.

In some implementations, the first calculation module 83 is configured to: determine a signal strength of the valid echo signal; determine a number of thresholds based on the signal strength of the valid echo signal; and determine the threshold for the valid echo signal based on a peak value of the valid echo signal, an extreme value of the valid echo signal and the number of thresholds.

In some implementations, the second calculation module 84 is configured to: determine, from the valid echo signal, a first sampling point that is earlier than a peak value and that satisfies that a difference between the first sampling point and the threshold is within a first preset range, and a second sampling point that is later than the peak value and that satisfies that a difference between the second sampling point and the threshold is within a second preset range; and perform an interpolation operation on a moment corresponding to the first sampling point to obtain the leading edge moment, and perform an interpolation operation on a moment corresponding to the second sampling point to obtain the trailing edge moment.

In some implementations, the third calculation module 85 is configured to: correct the preamble signal based on environment information when the echo signal is received, to obtain a corrected preamble signal; and perform a matching operation on the echo signal and the corrected preamble signal, to obtain the valid echo signal for the target object.

It should be noted that content such as information exchange and an execution process between the foregoing apparatuses or units is based on the same concept as the method embodiments of this application. For specific functions and technical effects thereof, reference may be made to the method embodiments. Details are not described herein again.

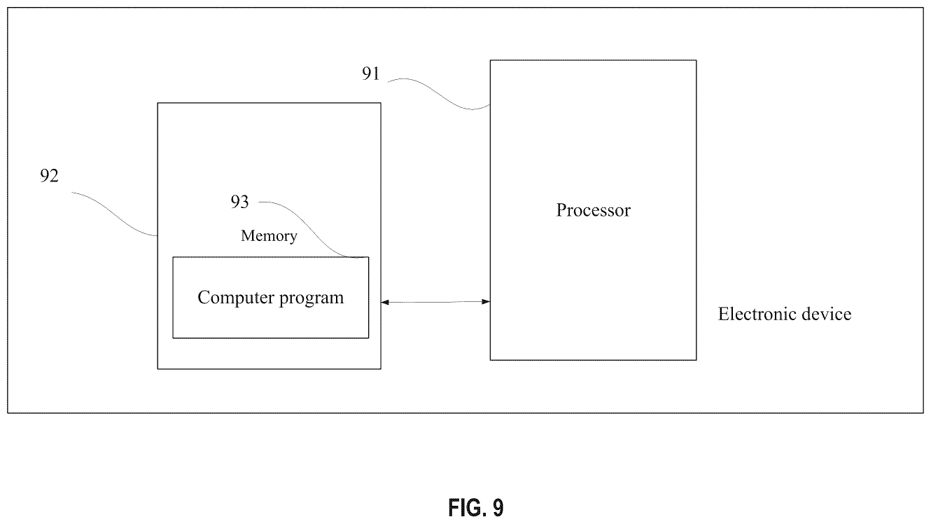

FIG. 9 is a schematic structural diagram of a LiDAR according to an embodiment of this application.

As shown in FIG. 9, the LiDAR includes: a processor 91, a memory 92, and a computer program 93 stored in the memory 92 and capable of running on the processor 91, where when the processor 91 executes the computer program 93, steps in the embodiments of the target detection method are implemented, for example, steps S201 to S205 shown in FIG. 2. In some embodiments, when the processor 91 executes the computer program 93, the functions of the modules/units in the foregoing apparatus embodiments are implemented, for example, the functions of the obtaining module 81 to the third calculation modules 85 shown in FIG. 8.

For example, the computer program 93 may be divided into one or more modules or units, and the one or more modules or units are stored in the memory 92 and are performed by the processor 91 to complete this application. The one or more modules or units may be a series of computer program instruction fields capable of completing specific functions, and the instruction fields are used to describe an execution process of the computer program 93 in the LiDAR.

A person skilled in the art can understand that FIG. 8 is only an example of the LiDAR, and does not constitute a limitation on the LiDAR. The terminal device may include more or fewer components than those shown in the figure, or a combination of some components, or different components. For example, the LiDAR may also include input and output devices, a network access device, a bus, and the like.

The processor 91 may be a central processing unit (CPU); or may be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The memory 92 may be an internal storage unit of the LiDAR, such as a hard disk or a memory of the LiDAR. The memory 92 may be an external storage device of the LiDAR, for example, a plug-connected hard disk, a smart media card (SMC), a secure digital (SD) card, or a flash card equipped on the LiDAR. Further, the memory 92 may include both the internal storage unit and the external storage device of the LiDAR. The memory 92 is configured to store the computer program and other programs and data required by the LiDAR. The memory 92 can also be configured to temporarily store output data or to-be-output data.

A person skilled in the art can clearly understand that, for the purpose of convenient and brief description, division of the foregoing functional units and modules is taken as an example for illustration. In actual application, the foregoing functions can he allocated to different units and modules and implemented according to a requirement, that is, an inner structure of an apparatus is divided into different functional units and modules to implement all or part of the functions described above. The functional units and modules in the embodiments may be integrated into one processing unit, or each unit may exist alone physically, or two or more units may be integrated into one unit. The integrated unit may be implemented in a form of hardware, or may be implemented in a form of a software functional unit. In addition, specific names of the functional units and modules are only for the convenience of distinguishing one another, and are not intended to limit the protection scope of this application. For a detailed working process of units and modules in the foregoing system, reference may be made to a corresponding process in the foregoing method embodiments. Details are not described again herein.

In the foregoing embodiments, the descriptions of the embodiments have respective focuses. For a part that is not described in detail in one embodiment, reference may be made to related descriptions in other embodiments.

In the embodiments provided in this application, it should he understood that the disclosed apparatus or LiDAR and method may be implemented in other manners. For example, the embodiments of the described apparatus or LiDAR are merely examples. For example, the module or unit division is merely logical function division and may be another division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not he physically separate, and parts displayed as units may or may not be physical units, may be located in one position, or may distributed on a plurality of network elements. Some or all of the units may be selected based on actual requirements to achieve the objectives of the solutions of the embodiments.

In addition, the functional units in the embodiments of this application may be integrated into one processing unit, or each of the units may exist alone physically, or two or more units may be integrated into one unit. The integrated unit may be implemented in a form of hardware, or may he implemented in a form of a software functional unit.

When the integrated module or unit is implemented in the form of a software functional unit and sold or used as an independent product, the integrated module or unit may be stored in a computer-readable storage medium. Based on such understanding, some or all of the processes for implementing the methods in the embodiments of this application may be completed by related hardware instructed by a computer program. The computer program may be stored in a computer-readable storage medium. When the computer program is executed by the processor, the steps of the foregoing method embodiments are implemented. The computer program includes computer program code, and the computer program code may be in a form of source code, object code, or an executable file, some intermediate forms, or the like. The computer-readable medium may include: any entity or apparatus capable of carrying the computer program code, a recording medium, a USB flash drive, a removable hard disk, a magnetic disk, an optical disc, a computer memory, a read-only memory (ROM), a random access memory (RAM), an electrical carrier signal, a telecommunications signal, a software distribution medium, or the like.

A person of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

The foregoing embodiments are merely intended to describe the technical solutions of this application, but not to limit this application. Although this application is described in detail with reference to the foregoing embodiments, persons ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. A target detection method, applied to a LiDAR, comprising:
obtaining an echo signal, wherein the echo signal is obtained by sampling an echo laser beam received by the LiDAR;
performing a matching operation on the echo signal and a preamble signal, to obtain a valid echo signal for a target object, wherein the preamble signal is obtained by sampling an echo laser beam corresponding to a window;
determining a threshold for the valid echo signal;
determining a leading edge moment and a trailing edge moment based on the threshold; and
determining a distance between the LiDAR and the target object based on the leading edge moment and the trailing edge moment.

2. The target detection method according to claim 1, wherein before performing the matching operation on the echo signal and the preamble signal, the method further comprises:
determining whether a signal strength of the echo signal is greater than a first preset value; and
reducing an emission power for an outgoing laser beam of the LiDAR, and obtaining an echo signal again, when it is determined that the signal strength of the echo signal is greater than the first preset value.

3. The target detection method according to claim 1, wherein before performing the matching operation on the echo signal and the preamble signal, the method further comprises:
determining a measured distance corresponding to the echo signal;
determining a similarity value between the echo signal and the preamble signal, when it is determined that the measured distance is less than a second preset value; and
performing the matching operation on the echo signal and the preamble signal, when the similarity value is less than a third preset value.

4. The target detection method according to claim 1, wherein performing the matching operation on the echo signal and the preamble signal comprises:
obtaining a preamble signal corresponding to the echo signal;
performing the matching operation on the echo signal and the preamble signal, to obtain an intersection point of the echo signal and the preamble signal; and
obtaining the valid echo signal based on the intersection point.

5. The target detection method according to claim 4, Wherein obtaining the preamble signal corresponding to the echo signal comprises:
determining an emission power for an outgoing laser beam corresponding to the echo signal; and
obtaining a preamble signal corresponding to the emission power.

6. The target detection method according to claim 1, wherein determining the threshold for the valid echo signal comprises:
determining a signal strength of the valid echo signal;
determining a number of thresholds based on the signal strength of the valid echo signal; and
determining the threshold for the valid echo signal based on a peak value of the valid echo signal, an extreme value of the valid echo signal and the number of thresholds.

7. The target detection method according to claim 1, wherein determining the leading edge moment and the trailing edge moment based on the threshold comprises:
determining, from the valid echo signal, a first sampling point that is earlier than a peak value and a second sampling point that is later than the peak value, wherein a difference between the first sampling point and the threshold is within a first preset mange and a difference between the second sampling point and the threshold is within a second preset range; and
performing an interpolation operation on a moment corresponding to the first sampling point to obtain the leading edge moment, and performing an interpolation operation on a moment corresponding to the second sampling point to obtain the trailing edge moment.

8. The target detection method according to claim 1, wherein performing the matching operation on the echo signal and the preamble signal comprises:
correcting the preamble signal based on environment information when the echo signal is received, to obtain a corrected preamble signal; and
performing the matching operation on the echo signal and the corrected preamble signal, to obtain the valid echo signal for the target object.

9. A LiDAR, comprising a memory, a processor, and a computer program stored in the memory, wherein when the processor executes the computer program, to implement processes comprising:
obtaining an echo signal, wherein the echo signal is obtained by sampling an echo laser beam received by the LiDAR;
performing a matching operation on the echo signal and a preamble signal, to obtain a valid echo signal for a target object, wherein the preamble signal is obtained by sampling an echo laser beam corresponding to a window;
determining a threshold for the valid echo signal;
determining a leading edge moment and a trailing edge moment based on the threshold; and
determining a distance between the LiDAR and the target object based on the leading edge moment and the trailing edge moment.

10. The LiDAR according to claim 9, wherein before performing the matching operation on the echo signal and the preamble signal, the processes further comprise:
determining whether a signal strength of the echo signal is greater than a first preset value; and
reducing an emission power for an outgoing laser beam of the LiDAR, and obtaining an echo signal again, when it is determined that the signal strength of the echo signal is greater than the first preset value.

11. The LiDAR according to claim 9, wherein before performing the matching operation on the echo signal and the preamble signal, the processes further comprise:
determining a measured distance corresponding to the echo signal;
determining a similarity -value between the echo signal and the preamble signal, when it is determined that the measured distance is less than a second preset value; and
performing the matching operation on the echo signal and the preamble signal, when the similarity value is less than a third preset value.

12. The LiDAR according to claim 9, wherein performing the matching operation on the echo signal and the preamble signal comprises:
obtaining a preamble signal corresponding to the echo signal;
performing the matching operation on the echo signal and the preamble signal, to obtain an intersection point of the echo signal and the preamble signal; and
obtaining the valid echo signal based on the intersection point.

13. The LiDAR according to claim 12, wherein obtaining the preamble signal corresponding to the echo signal comprises:
determining an emission power for an outgoing laser beam corresponding to the echo signal; and
obtaining a preamble signal corresponding to the emission power.

14. The LiDAR according to claim 9, wherein determining the threshold for the valid echo signal comprises:
determining a signal strength of the valid echo signal;
determining a number of thresholds based on the signal strength of the valid echo signal; and
determining the threshold for the valid echo signal based on a peak value of the valid echo signal, an extreme value of the valid echo signal and the number of thresholds.

15. The LiDAR according to claim 9, wherein determining the leading edge moment and the trailing edge moment based on the threshold comprises:
determining, from the valid echo signal, a first sampling point that is earlier than a peak value and a second sampling point that is later than the peak value, Wherein a difference between the first sampling point and the threshold is within a first preset range and a difference between the second sampling point and the threshold is within a second preset range; and
performing an interpolation operation on a moment corresponding, to the first sampling point to obtain the leading edge moment, and performing an interpolation operation on a moment corresponding to the second sampling point to obtain the trailing edge moment.

16. The LiDAR according to claim 9, wherein performing the matching operation on the echo signal and the preamble signal comprises:
correcting the preamble signal based on environment information when the echo signal is received, to obtain a corrected preamble signal; and
performing the matching operation on the echo signal and the corrected preamble signal, to obtain the valid echo signal for the target object.

17. A non-transitory computer-readable storage medium, storing a computer program, when the computer program is executed by a processor of a LiDAR, causes the processor to implement processes comprising:
obtaining an echo signal, wherein the echo signal is obtained by sampling an echo laser beam received by the LiDAR;
performing a matching operation on the echo signal and a preamble signal, to obtain a valid echo signal for a target object, wherein the preamble signal is obtained by sampling an echo laser beam corresponding to a window;
determining a threshold for the valid echo signal;
determining a leading edge moment and a trailing edge moment based on the threshold; and
determining a distance between the LiDAR and the target object based on the leading moment and the trailing edge moment.

18. The non-transitory computer-readable storage medium according to claim 17, wherein before performing the matching operation on the echo signal and the preamble signal, the processes further comprise:
determining whether a signal strength of the echo signal is greater than a first preset value; and
reducing an emission power for an outgoing laser beam of the LiDAR, and obtaining an echo signal again, when it is determined that the signal strength of the echo signal is greater than the first preset value.

19. The non-transitory computer-readable storage medium according to claim 17, wherein performing the matching operation on the echo signal and the preamble signal comprises:
obtaining a preamble signal corresponding to the echo signal;
performing the matching operation on the echo signal and the preamble signal, to obtain an intersection point of the echo signal and the preamble signal; and
obtaining the valid echo signal based on the intersection point.

20. The non-transitory computer-readable storage medium according to claim 19, wherein obtaining the preamble signal corresponding to the echo signal comprises:
determining an emission power for an outgoing laser beam corresponding to the echo signal; and
obtaining a preamble signal corresponding to the emission power.
